(19) United States
(12) Patent Application Publication
(10) Pub. No.: US 2013/0325673 A1
(43) Pub. Date: Dec. 5, 2013

(54) COORDINATE MODEL FOR INVENTORY VISUALIZATION IN CONJUNCTION WITH PHYSICAL LAYOUT

(71) Applicants: Mirza Abdic, Copenhagen (DK); Lennart Conrad, Copenhagen (DK)

(72) Inventors: Mirza Abdic, Copenhagen (DK); Lennart Conrad, Copenhagen (DK)

(73) Assignee: Microsoft Corporation, Redmond, WA (US)

(21) Appl. No.: 13/488,810

(22) Filed: Jun. 5, 2012

(51) Int. Cl. G06Q 10/08

(52) U.S. Cl. 705/28

(57) ABSTRACT

A visualization application in conjunction with an enterprise resource planning (ERP) service draws a store map employing a coordinate model. Upon receiving aisle data including coordinate and orientation information for each aisle, the aisles are mapped within the store map using the aisle locations determined from the aisle data. The physical store map is integrated with visualized inventory information such as a heat map to enable users view inventory information, trends, etc. with the location information as background.

### BACKGROUND

Enterprise resource planning (ERP) systems integrate organizational information management. ERP systems automate information flow across platforms and organizational environments, and they provide integrated solutions to finance, manufacturing, sales, and customer relationship management environments. ERP systems include some common characteristics such as integrated solutions functioning in real time, with a common database, consistent user interface elements, and common installation and configuration components. Common characteristics simplify information technology department processes for installation and management. Additionally, integrated ERP system solutions are deployed with a high level of customization and features to meet customer requirements. As a result, ERP system solutions have high installation costs but save the customer costs in the long run through their integrated features.

Inventory management in ERP systems can be difficult to implement. Dynamic nature of inventory complicates many management tasks such as tracking and maintaining stocks. Additionally, business process improvements involve rules to analyze inventory movements within inventory stores. Graphical presentations of inventory stores typically lack the ability to represent the finer details needed to visualize inventory movements. Modern systems usually represent the inventory data through structured data tables. Current solutions fail to transpose the structured inventory data to graphical representations of an inventory store.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to employing a coordinate system to draw a store map within an ERP system. According to some embodiments, an application may receive aisle data of a store. The aisle data may include location and attribute information about the aisles within the store. Next, the application may determine aisle locations from the aisle data according to a coordinate system. The coordinate system may be a Cartesian coordinate system, for example. Subsequently, the application may map aisles within the store map using the aisle locations enabling the users to visualize store layout along with inventory information providing a heat map.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example network diagram where a coordinate model for inventory visualization in conjunction with physical layout may be employed according to some embodiments;

FIG. 2 illustrates an example entity relationship diagram for employing a coordinate model for inventory visualization in conjunction with physical layout according to embodiments;

FIG. 3 illustrates an example store map drawn by employing a coordinate system according to embodiments;

FIG. 4 illustrates another example store map drawn by employing a coordinate system while overlaying additional features according to embodiments;

FIG. 5 illustrates an example user interface displaying inventory visualization in conjunction with physical layout according to embodiments;

FIG. 6 is a networked environment, where a system according to embodiments may be implemented;

FIG. 7 is a block diagram of an example computing operating environment, where embodiments may be implemented; and

FIG. 8 illustrates a logic flow diagram for a process employing a coordinate model for inventory visualization in conjunction with physical layout according to embodiments.

### DETAILED DESCRIPTION

As briefly described above, an application may draw a store map for an ERP system by employing a coordinate system. The application may receive aisle data of a store. The aisle data may include coordinate and direction information about the aisles. The application may determine the aisle locations according to a coordinate system. The coordinate system may be a Cartesian coordinate system or similar ones and depend on the top left corner of the store as a reference point to draw the aisles. Next, the application may map the aisles within the store map using the aisle locations. The application may position the top left corner of the aisles in relation to the top left corner of the store map using the aisle coordinates and direction.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present disclosure is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a non-transitory computer-readable memory device. The computer-readable storage medium can for example be implemented via one or more of a volatile computer memory, a non-volatile memory, a hard drive, a flash drive, a floppy disk, or a compact disk, and comparable media.

According to embodiments, a store may be any structure with inventory partitioned to aisles. Examples may include warehouses, retail stores, pharmacies, etc. The aisles may have horizontal and vertical directions when viewing the store map from a top position. Alternatively, the aisles may have directions in any angle. The store map may be drawn according to a coordinate system such as Cartesian coordinate system. The store map may have a top left corner or any other point as a reference point to position the aisles. Each aisle may be positioned according to the reference point of the store map. In addition, each aisle may be partitioned to shelves. Each aisle may have multiple shelves within a horizontal and a vertical plane of the aisle.

Throughout this specification, the term “platform” may be a combination of software and hardware components for employing a coordinate system to draw a store map. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

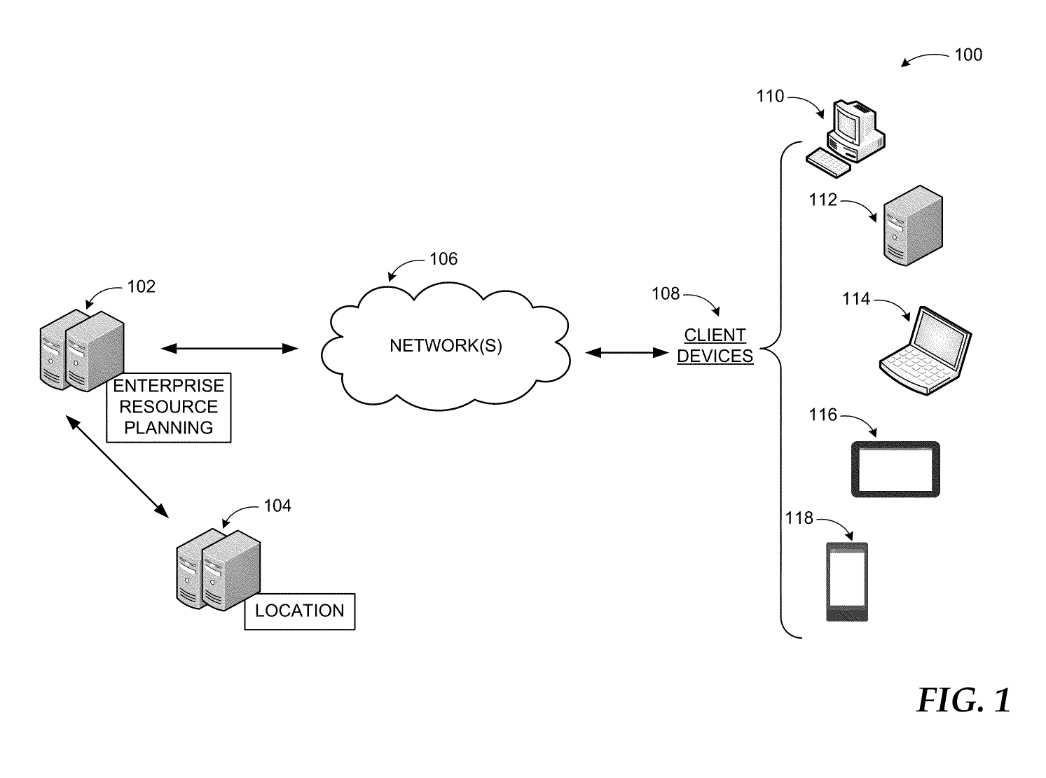

Referring to FIG. 1, diagram 100 illustrates an example network diagram where a coordinate model for inventory visualization in conjunction with physical layout may be employed according to some embodiments. The components and environments shown in diagram 100 are for illustration purposes. Embodiments may be implemented in various local, networked, cloud-based and similar computing environments employing a variety of computing devices and systems, hardware and software.

In an example environment illustrated in diagram 100, one or more enterprise resource planning (ERP) servers 102 may execute an application drawing a store map employing a coordinate system. The application may retrieve location data about structures in the store (such as aisles) from a location provider 104. The location provider 104 may store location information such as coordinates and direction for each aisle. Additionally, the location provider 104 may store finer detail as location information for shelves of aisles. In an example scenario, the location provider 104 may use global positioning satellite (GPS) hardware to track the location of each aisle or each shelf. Using the map information, inventory tracking services may be provided to users through the ERP servers 102. For example, amount of goods on a particular shelf at a selected aisle may be monitored and a user alerted if the goods need to be replenished/replaced/removed.

According to some embodiments, the application may transmit a store map to client devices 108 through network(s) 106. The network(s) may be any communication system between the ERP server 102 and the client devices 108 such as wired and wireless networks. The client devices may encompass a variety of devices including a desktop computer 110, another server 112, a laptop computer 114, a tablet (or slate) 116, a smart phone 118, etc. The application may display the store map at client devices 108 through a client application. The client application may enable a user to interact with the store map view inventory levels, other inventory related information, and similar visualizations.

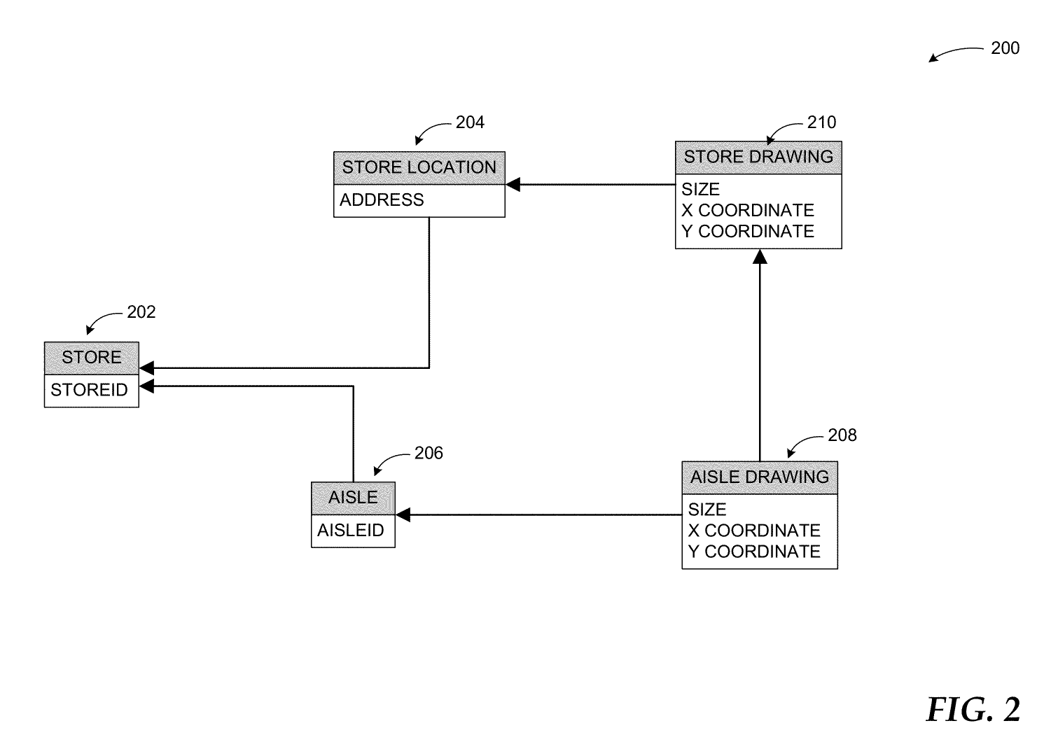

FIG. 2 illustrates an example entity relationship diagram for employing a coordinate model for inventory visualization in conjunction with physical layout according to embodiments. Diagram 200 displays data tables for an example data schema for employing a coordinate system to draw a store map.

According to some embodiments, a visualization application within an ERP system may access a store table 202 to retrieve attribute information about the store such as store id (identification), store description, etc. The store table 202 may be related to store location table 204. The store location table 204 may store location attributes about the store such as an address. The store may be any facility where inventory is tracked such as a warehouse, a loading facility, a retail store, and similar ones. The store location table 204 may be related to a store drawing table 210 including physical attributes such as size, x-coordinate and y-coordinate attributes of the store map, etc. Size and coordinate information in the store drawing table 210 may be used to draw the store map according to display specifications of a user interface. In an example scenario, a row in the store table representing a store may be linked to attributes in the store location and the store drawing tables encapsulating extended information about the store and the store map.

According to other embodiments, the store table 202 may be related to an aisle table 206. The aisle table 206 may include attributes of the aisle such as aisle id and aisle description. The aisle table 206 may also include links to shelf tables with information about shelves and inventory located on the shelves. The aisle table 206 may be related to aisle drawing 208. The aisle drawing 208 may include physical attributes of an aisle to construct a drawing including size, x-coordinate, and y-coordinate of an aisle. One or more aisle drawings may be related to a store drawing representing aisles within a store.

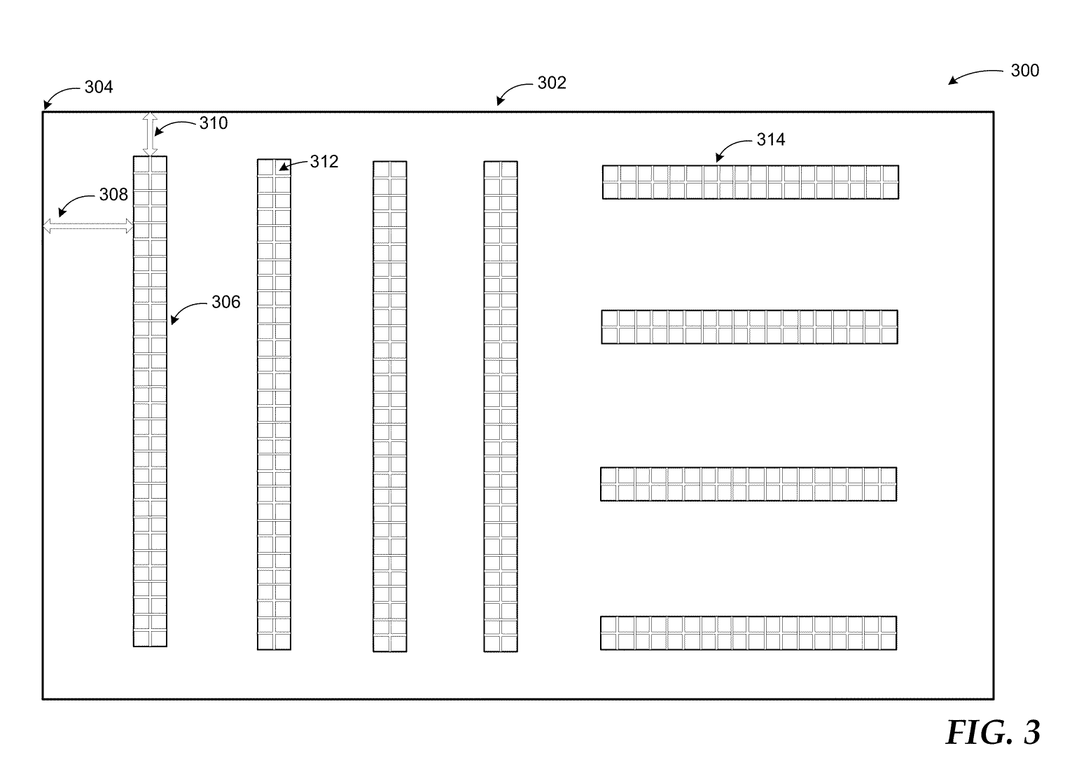

FIG. 3 illustrates an example store map drawn by employing a coordinate system according to embodiments. Diagram 300 displays a store map 302 with aisles laid out in perpendicular orientations shown through a top view (horizontally and vertically in the top view). A visualization application may retrieve store data and aisle data from an ERP system and draw the store map integrating the physical layout with a heat map or similar visualizations enabling viewing of inventory-related information in conjunction with the store map.

According to some embodiments, the application may use a top left corner 304 of the store as a reference point to position the store boundaries and the aisles. The application may draw boundaries of the store map according to size information retrieved about the store. The application may also retrieve aisle data including coordinate information and directions of the aisles. The aisle data may also include distance information such as a distance to left boundary 308 and distance to an upper boundary 310 between the aisle and the store boundaries. The aisle data may also include distance information between the aisle and other aisles or other objects within the store. Other objects may include physical structure of the store such as walls, rooms, windows, doors, etc. The application may place an aisle 306 in an orientation on the map based on a detected orientation of the aisle. The application may also partition the aisles to individual shelves such as a shelf 312. Each shelf may include goods whose inventory levels, attributes (e.g. expiration dates), etc. is being tracked by the ERP system.

Embodiments are not directed to perpendicular placement of aisles (horizontal and vertical in the top view). Aisle data may indicate any angular direction which may determine the directional drawing of the aisle within the store map. In case of non-perpendicularly placed aisles, other coordinate systems such as polar coordinates may be employed.

According to some embodiments, the application may use a Cartesian coordinate system having x- and y-axis coordinates for each entity inserted into the store map. The application may determine an x-coordinate and a y-coordinate and a direction of each aisle from the aisle locations provided in the aisle data. The application may draw each aisle in relation to a top left corner of the store map. The application may position the top left corners of each aisle in relation to the top left corner of the store map. The top left corner of the store map may have an x-coordinate value of zero and a y-coordinate value of zero. The application may draw the aisles according to size and partitioning information retrieved from the aisle data. Each aisle may be partitioned to shelves as discussed above. In other embodiments, other locations on the store map may be selected as a reference point too.

According to further embodiments, the application may retrieve shelf data from the aisle data for each aisle. The shelf data may include one or more attributes about goods stored on the shelves such as inventory information including identification, pricing, expiration date, frequency of movement, etc. The application may visualize each shelf within each aisle based on the shelf data according to a scheme such as a coloring scheme, a shading scheme, a textual scheme, and so on. For example, a heat map may be generated based on the shelf data overlaid on the physical map of the store. A heat map is a graphical representation of data where the individual values contained in a matrix are represented as colors. In one example implementation, a frequency of movement may be displayed according to a color scheme enabling users to determine visually which aisles and shelves have goods that move frequently. Other inventory attributes may be also be visualized in a similar manner.

In some embodiments, the application may construct the scheme as a range subsequent to an analysis of the shelf data for each shelf within each aisle. Following the example of frequency of movement above, a low value may be assigned to items that are seldom moved and a high value to items that are moved frequently. The application may determine a range from the low and high values and assign each shelf a value from the range according to matching frequencies of movement. In an example scenario, the application may assign a color range, a shading range, or a custom legend range as the range of values to the shelves. A custom legend range may be a set of fill shapes determined according to user specifications defining the range of values. For example, a plus shape as a fill shape may represent a distant expiration date. A cross shape as a fill shape of a shelf may represent an approaching expiration date of inventory within the shelf. In yet other embodiments, key performance indicator (KPI) warehouse data may be mapped for investigation of trends in the heat map of the warehouse.

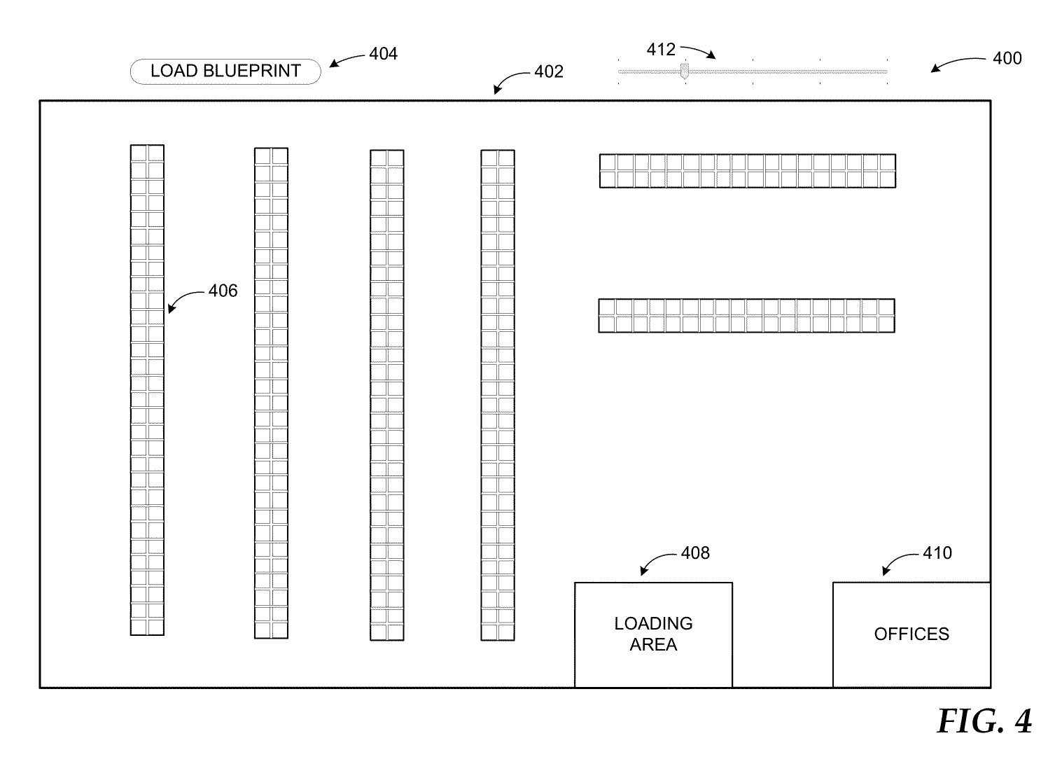

FIG. 4 illustrates another example store map drawn by employing a coordinate system while overlaying additional features according to embodiments. Diagram 400 displays a store map 402 with overlaid content. The store map 402 may display aisles 406 and other aisles oriented perpendicularly to the aisles 406. As discussed above, the orientation of the aisles may be determined according to aisle locations retrieved from aisle data. Aisle data may be formatted in extensible markup language (XML) format or comparable formats and stored as a flat file or as a table within a data store.

According to some embodiments, the application may overlay a store blueprint on top of the store map. The application may overlay the blueprint through a user action activating a control to load the blueprint 404. The blueprint may display structures of the store such as a loading area 408 and offices 410. In addition, the application may also provide a filter control 412 to have the application highlight shelves matching a selected value in the filter. An example may be juxtaposing a range of shelf attribute values on the filter control 412 and highlighting the shelves that match the selected value on the filter control. In an example scenario, a user may select a low value on the filter control to highlight shelves having items with upcoming expiration dates. The filter may correspond to a range of values about a single attribute of an inventory within the shelf or multiple attributes about the inventory. In some example implementations, smart sliders or drop down menus may be employed for quick filtering.

According to other embodiments, the application may enable interactions with inventory. For example, in response to detecting a user request through the application user interface to move items on a shelf from an aisle to another shelf within the same aisle or at a different aisle, the application may generate an instruction to a store employee to move the items according to the detected request. In another example scenario, a user may identify items with low movement rate signifying low overturn. The user may select to move the items to the back of the store. The application may print out instructions to have a store employee to move the items to the back of the store. The store employee may move the items and affirm the move through the ERP system. The application may redraw the store map to indicate the repositioned items.

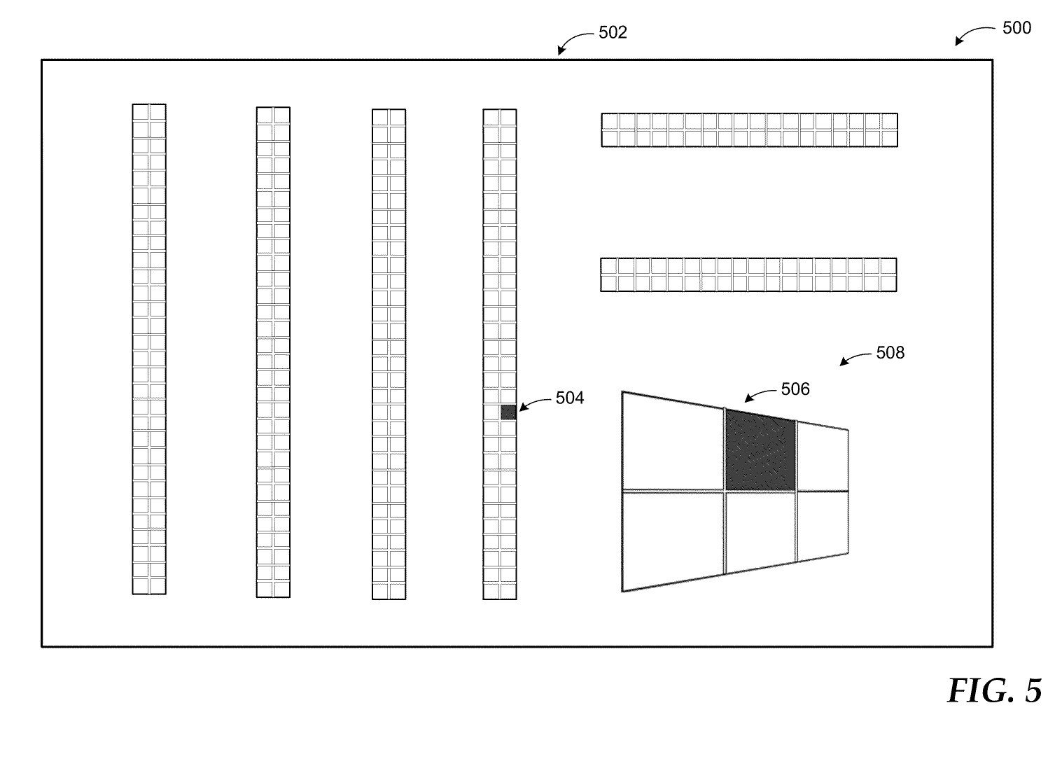

FIG. 5 illustrates an example user interface displaying inventory visualization in conjunction with physical layout according to embodiments. Diagram 500 depicts how details about a portion of an aisle may be displayed upon user selection. A user interface for the visualization application may display the store map 502. The store map 502 may display aisles overlaid with a visualization of inventory information such as a heat map. In response to a user selection of a portion of an aisle 504, the shelves on the selected portion of the aisle 504 may be displayed in higher detail on a new view pane such as a pop-up window or an empty portion of the store map 502.

In a top view mode, the attributes of items on different shelves may be displayed in a combined fashion. For example, the storage facility that is being mapped may include four levels of shelves on each aisle. In a particular location, the items on the lower two shelves may be fast moving items, while the top two shelves may store items with low frequency of movement. In a top view heat map, the movement frequency of the items for the four shelves may be averaged or otherwise combined resulting in loss of the granularity of information. In a system according to embodiments, the detailed view 508 may present a portion of the heat map at shelf-level granularity enabling a user to determine, for example, that shelf 506 has fast moving items, while the other shelves store slow moving items.

The detailed view 508 may also display the adjoining shelves, as well as information about the attributes of the inventory within the shelves beyond what's illustrated by the shelf scheme. Examples may include pop-up text of attributes for each individual shelf within the detailed view 508. The detailed view 508 may also provide a more accurate 3D view of the shelf and aisle structure in some embodiments. The number of adjacent stack of shelves within the pane may be dependent on a predetermined system setting or may be adjustable according to available display real estate.

According to other embodiments, the application may read a geo-tag of each shelf to maintain dynamic shelf locations. The geo-tag may be GPS hardware. Alternatively, the geo-tag may be wireless transmitters reporting shelf location to a base station. The application may detect a query for an inventory, determine a shelf geo-tag for a shelf containing the inventory, locate the shelf according to the shelf geo-tag within an aisle, and highlight the shelf within the store map.

According to yet other embodiments, the application may detect a user action selecting a shelf from the aisles. The application may display other store maps with shelves matching at least one attribute of the selected shelf alongside the store map. The application may highlight the matching shelves. The application may also highlight matching shelves within the same store map. In addition, the user may be enabled to select individual aisles to display in the store map through a selection table displaying information about the aisles. Although embodiments are described using a Cartesian coordinate system, other coordinate systems may be used to draw the store map. In an example scenario, a polar coordinate system may be used to draw the store map. The application may draw a circular store map to represent a store having aisles placed according to a wheel and spoke system.

According to further embodiments, the application may provide a touch or gesture based user interface. A user may be enabled to select aisles or shelves from the store map through gesture or touch based input. An example may include touching or gesturing to a shelf to launch a detailed view about the shelf and adjoining shelves. In another example scenario, the application may enable the user to zoom in and out of any section of the store map using gestures such as pinch-to-zoom. Upon detecting a two or more fingered slide action approaching a center point, the user interface may zoom into the center point of the slide action within the store map. Similarly, in response to detecting a two or more fingered slide action moving away from a center point, the user interface may zoom out of the center point of the slide action within the store map. The user may also be enabled to slide to different sections of the store map (if the map is larger than the display area). Other forms of input such as keyboard, pen, speech, etc. may also be employed to enable interaction with the visualization application user interface. The gesture may be detected optically or inertially (e.g., through a camera or an inertial input device).

The example scenarios and schemas in FIG. 2 through 5 are shown with specific components, data types, and configurations. Embodiments are not limited to systems according to these example configurations. Employing a coordinate system to draw a store map may be implemented in configurations employing fewer or additional components in applications and user interfaces. Furthermore, the example schema and components shown in FIG. 2 through 5 and their subcomponents may be implemented in a similar manner with other values using the principles described herein.

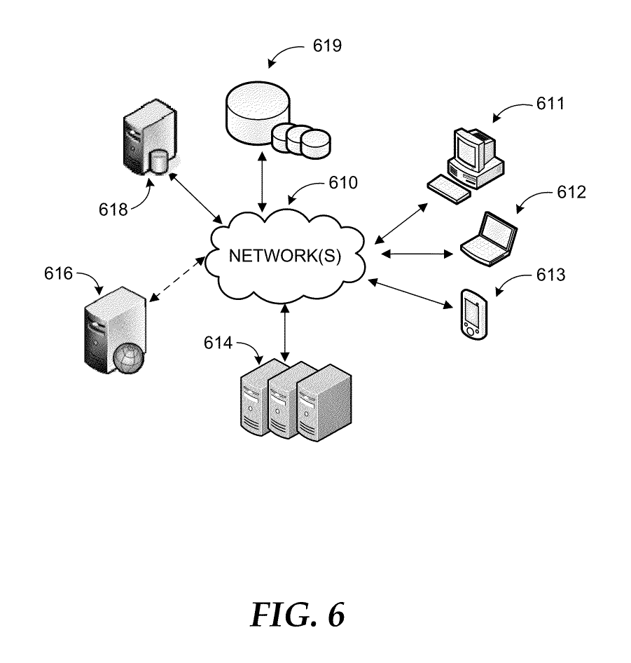

FIG. 6 is a networked environment, where a system according to embodiments may be implemented. Local and remote resources may be provided by one or more servers 614 or a single server (e.g. web server) 616 such as a hosted service. An application may communicate with client interfaces on individual computing devices such as a smart phone 613, a laptop computer 612, or desktop computer 611 (‘client devices’) through network(s) 610.

As discussed above, a visualization application within an ERP system may receive aisle data of a store, determine aisle locations from the aisle data according to a coordinate system, and map aisles within the store map using the aisle locations enabling the users to visualize store layout along with inventory information providing a heat map. Client devices 611-613 may enable access to applications executed on remote server(s) (e.g. one of servers 614) as discussed previously. The server(s) may retrieve or store relevant data from/to data store(s) 619 directly or through database server 618.

Network(s) 610 may comprise any topology of servers, clients, Internet service providers, and communication media. A system according to embodiments may have a static or dynamic topology. Network(s) 610 may include secure networks such as an enterprise network, an unsecure network such as a wireless open network, or the Internet. Network(s) 610 may also coordinate communication over other networks such as Public Switched Telephone Network (PSTN) or cellular networks. Furthermore, network(s) 610 may include short range wireless networks such as Bluetooth or similar ones. Network(s) 610 provide communication between the nodes described herein. By way of example, and not limitation, network(s) 610 may include wireless media such as acoustic, RF, infrared and other wireless media.

Many other configurations of computing devices, applications, data sources, and data distribution systems may be employed to draw a store map employing a coordinate system. Furthermore, the networked environments discussed in FIG. 6 are for illustration purposes only. Embodiments are not limited to the example applications, modules, or processes.

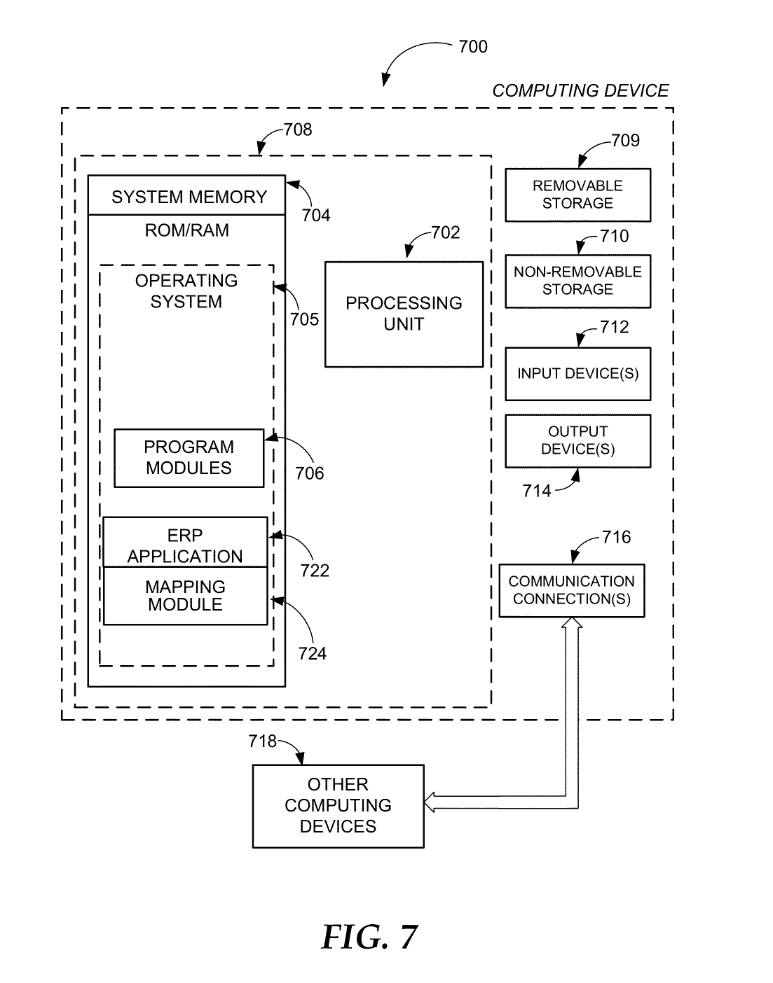

FIG. 7 and the associated discussion are intended to provide a brief, general description of a suitable computing environment in which embodiments may be implemented. With reference to FIG. 7, a block diagram of an example computing operating environment for an application according to embodiments is illustrated, such as computing device 700. In a basic configuration, computing device 700 may include at least one processing unit 702 and system memory 704. Computing device 700 may also include a plurality of processing units that cooperate in executing programs. Depending on the exact configuration and type of computing device, the system memory 704 may be volatile (such as RAM), non-volatile (such as ROM, flash memory, etc.) or some combination of the two. System memory 704 typically includes an operating system 705 suitable for controlling the operation of the platform, such as the WINDOWS® operating systems from MICROSOFT CORPORATION of Redmond, Wash. The system memory 704 may also include one or more software applications such as program modules 706, visualization application 722, and mapping module 724.

Visualization application 722 may be part of an ERP system monitoring and managing inventory. The mapping module 724 in conjunction with the visualization application 722 may receive aisle data of a store, determine aisle locations from the aisle data according to a coordinate system, and map aisles within the store map using the aisle locations enabling the users to visualize store layout along with inventory information providing a heat map. This basic configuration is illustrated in FIG. 7 by those components within dashed line 708.

Computing device 700 may have additional features or functionality. For example, the computing device 700 may also include additional data storage devices (removable and/or non-removable) such as, for example, magnetic disks, optical disks, or tape. Such additional storage is illustrated in FIG. 7 by removable storage 709 and non-removable storage 710. Computer readable storage media may include volatile and nonvolatile, removable and non-removable media implemented in any method or technology for storage of information, such as computer readable instructions, data structures, program modules, or other data. Computer readable storage media is a non-transitory computer readable memory device. System memory 704, removable storage 709 and non-removable storage 710 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer readable storage media may be part of computing device 700. Computing device 700 may also have input device(s) 712 such as keyboard, mouse, pen, voice input device, touch input device, and comparable input devices. Output device(s) 714 such as a display, speakers, printer, and other types of output devices may also be included. These devices are well known in the art and need not be discussed at length here.

Computing device 700 may also contain communication connections 716 that allow the device to communicate with other devices 718, such as over a wireless network in a distributed computing environment, a satellite link, a cellular link, and comparable mechanisms. Other devices 718 may include computer device(s) that execute communication applications, storage servers, and comparable devices. Communication connection(s) 716 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

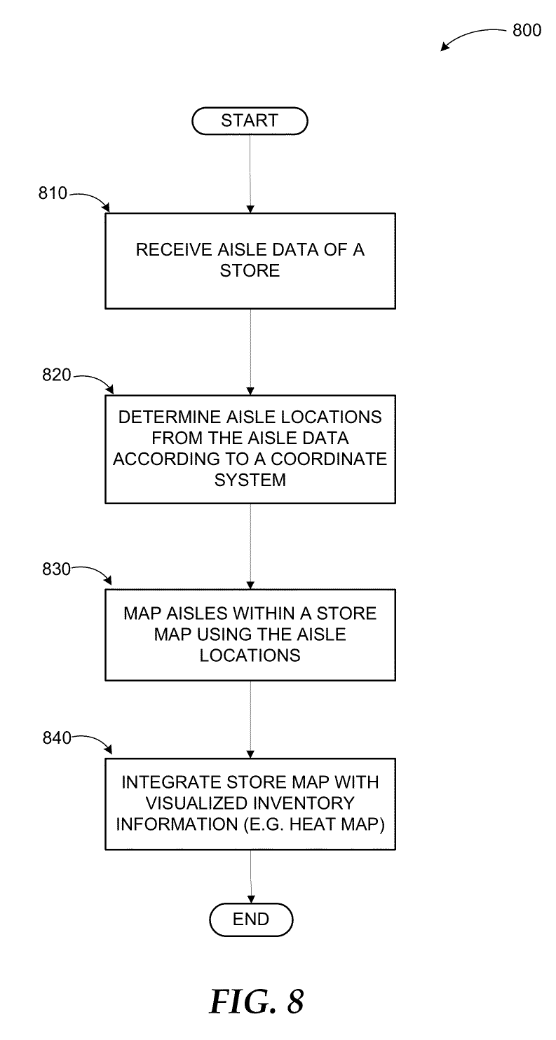

FIG. 8 illustrates a logic flow diagram for a process employing a coordinate model for inventory visualization in conjunction with physical layout according to embodiments. Process 800 may be implemented by a visualization application within an ERP service in some examples.

Process 800 may begin with operation 810 where a visualization application may receive aisle data of a store. The aisle data may include size and distance information of each aisle from other objects, store boundaries, and other aisles. At operation 820, the application may determine aisle locations from the aisle data according to a coordinate system. The coordinate system may be a Cartesian coordinate system. The aisle locations may include coordinates and orientation for each aisle. Subsequently, the application may map aisles within the store map using the aisle location at operation 830. The visualization application may integrate the store map with visualized inventory information such as a heat map at operation 840 and enable users to interact through the user interface viewing details, providing instructions for store activities, etc.

Some embodiments may be implemented in a computing device that includes a communication module, a memory, and a processor, where the processor executes a method as described above or comparable ones in conjunction with instructions stored in the memory. Other embodiments may be implemented as a computer readable storage medium with instructions stored thereon for executing a method as described above or similar ones.

The operations included in process 800 are for illustration purposes. Employing a coordinate model for inventory visualization in conjunction with physical layout according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

1. A method executed on a computing device for employing a coordinate model for inventory visualization in conjunction with physical layout, the method comprising:
receiving aisle data of a store by accessing one or more data tables including data schema through one of a communication module and an input module of the computing device;
determining aisle locations from the aisle data according to the coordinate model at a processor of the computing device;
mapping aisles within a store map using the aisle locations at the processor of the computing device, wherein a reference point is selected to position the aisles within the store map;
integrating an inventory information visualization with the store map at the processor of the computing device; and
providing the integrated store map and inventory information visualization to one of a display device and another computing device for display.

2. The method of claim 1, further comprising:
accessing a store table stored in one of a removable data storage and non-removable data storage associated with the computing device to retrieve attribute information about the store including at least one of a store identifier, a store description, and a store location.

3. The method of claim 1, further comprising:
at the processor of the computing device, including in the coordinate model a store drawing table storing physical attributes of the store including at least one from a set of: a size, an x-coordinate attribute, a y-coordinate attribute, one or more features of the store, and one or more boundaries of the store.

4. The method of claim 3, further comprising:
at the processor of the computing device, including in the coordinate model an aisle table storing aisle attributes including an aisle identifier for each aisle, an aisle description for each aisle, and one or more links to shelf tables with information about shelves and inventory located on the shelves.

5. The method of claim 4, further comprising:
at the processor of the computing device, including in the information about the shelves at least one from a set of: inventory levels, attributes, identification, pricing, expiration dates, and a frequency of movement of the goods stored on the shelves.

6. The method of claim 1, further comprising:
providing a visualization of the information about the shelves employing one or more of a coloring scheme, a shading scheme, a textual scheme, and a graphics scheme at a display device associated with the computing device.

7. The method of claim 6, further comprising:
providing a heat map in the visualization at the display device associated with the computing device.

8. The method of claim 7, further comprising:
mapping key point indicator (KPI) data associated with the store for investigation of trends in the heat map of the store at the processor of the computing device.

9. The method of claim 1, further comprising:
providing a filtering control on a visualization application user interface to enable selection of aisles and shelves at the processor of the computing device.

10. The method of claim 9, further comprising:
providing one or more of a smart slider and a drop-down menu at the display device associated with the computing device as part of the filtering control for quick filtering.

11. The method of claim 1, further comprising:
in response to a selection of a portion of an aisle, providing a detail view of one or more shelves at the selected portion of the aisle at one of a new view pane and an empty portion of the store map at the display device associated with the computing device.

12. A computing device for employing a coordinate model for inventory visualization in conjunction with physical layout, the computing device comprising:
a memory configured to store instructions; and
a processor coupled to the memory, the processor executing a visualization application in conjunction with the instructions stored in the memory, wherein the visualization application is configured to:
receive aisle data of a store;
determine aisle locations from the aisle data according to the coordinate model;
map aisles within a store map using the aisle locations;
integrate an inventory information visualization with the store map, the inventory information visualization including a heat map;
map key point indicator (KPI) data associated with the store for investigation of trends in the heat map of the store;
read a geo-tag associated with each aisle or each shelf within the aisle to maintain dynamic inventory, wherein the geo-tag is global positioning satellite (GPS) hardware; and
provide the integrated store map and inventory information visualization to one of a display device and another computing device for display.

13. The computing device of claim 12, wherein the visualization application is further configured to:
overlay a blueprint of the store over the store map to display structures of the store.

14. The computing device of claim 12, wherein the visualization application is further configured to:
select a reference point; and
lay out the store map by placing aisles using Cartesian coordinates in relation to the reference point based on distances and orientations of the aisles determined from the aisle data.

15. The computing device of claim 12, wherein the application is further configured to:
detect a gesture based selection of a portion of an aisle;
display one of a detail view of one or more shelves at the selected portion of the aisle, other store maps with shelves matching at least one attribute of the one or more shelves at the selected portion of the aisle, and shelves matching the at least one attribute of the one or more shelves at the selected portion of the aisle within the same store map;
enable at least one from a set of a control action, a zoom action, and a slide action on the displayed store map through gesture based input.

16. The computing device of claim 15, wherein the gesture is one of a touch gesture, an optically detected gesture, and an inertially detected input.

17. A computing device for employing a coordinate model for inventory visualization in conjunction with physical layout, the computing device comprising:
a memory configured to store instructions;
a processor coupled to the memory, the processor executing a visualization application in conjunction with the instructions stored in the memory, wherein the visualization application is configured to:
provide an integrated store map and inventory information visualization to a display device;
provide a filtering control on a visualization application user interface of the display device to enable selection of aisles and shelves;
detect a user request through the visualization application user interface;
in response to detection of the user request, generate an instruction to implement the user request; and
in response to an affirmation that the user request was implemented, redraw the integrated store map and inventory information visualization to reflect the implementation; and
the display device comprising a touch or gesture based visualization application user interface, wherein the display device is configured to:
receive the integrated store map and inventory information visualization from the visualization application, wherein the integrated store map and inventory visualization is displayed at one or more client devices through a client application;
enable a user to input a request through the visualization application user interface; and
enable a user to affirm that the user request was implemented through the visualization application user interface.

18. The computing device of claim 17, wherein aisle data used to create the integrated store map and inventory information visualization is formatted in extensible markup language (XML) format and stored as one of a flat file and a table within a data store.

19. The computing device of claim 17, wherein the visualization application is further configured to:
receive a request associated with movement of items on one or more shelves through the visualization application user interface; and
provide instructions to store management associated with the request.

20. The computing device of claim 17, wherein the store is one of as a warehouse, a loading facility, and a retail store.
